(19) United States
(12) Patent Application Publication
(10) Pub. No.: US 2006/0201980 A1
(43) Pub. Date: Sep. 14, 2006

(54) Vehicle mounting systems

(76) Inventor: Karl Koons, Phoenix, AZ (US)

Correspondence Address: WEISS & MOY PC, 4204 NORTH BROWN AVENUE, SCOTTSDALE, AZ, 85251, US

(21) Appl. No.: 11/076,605

(22) Filed: Mar. 10, 2005

(51) Int. Cl. B66D 1/00

(52) U.S. Cl. 224/511; 254/323

(57) ABSTRACT

An improved receiver hitch having a plurality of receivers is provided. The improved receiver hitch may be used with inserts that are slidably mounted into one or more of the plurality of receivers. The improved receiver hitch may be used with an insert such as a winch carrier in a winch mounting assembly or with other inserts such as ball mounts, clevis mounts, etc. The improved receiver hitch enables better handling, increased capacity, etc.

### FIELD OF THE INVENTION

This invention relates generally to vehicle hitches and, more specifically, to an improved receiver style hitch in a winch mounting system and a method of using the same.

### BACKGROUND OF THE INVENTION

A typical vehicle mounting system includes a hitch which attaches directly to the vehicle to provide a connection between the vehicle and a trailer or other attachment. The hitch may be factory installed on original bumpers or frames or may be welded or bolted onto bumpers or vehicle frames after market. It is helpful to have hitches on both the front and rear of the vehicle for versatility. A hitch may be a weight carrying hitch or may include a weight distribution system that enhances handling and braking and increases capacity beyond what is recommended when a weight-carrying hitch is used.

A standard receiver style hitch has one receiver. The standard receiver style hitch includes a main cross tube with the one receiver in the center thereof in a direction perpendicular to the main cross tube. The receiver is the receptacle part of the hitch which accommodates inserts. A common receiver style hitch is a square tube hitch with a two inch square receptacle for receiving inserts, although round tube hitches and other receiver sizes are available. The receiver is typically about seven inches long. An insert is any item that slides into the receptacle of a receiver style hitch. Exemplary inserts include drawbars, ball mounts, bike racks, winch carriers, etc.

The main cross tube may include mounting plates or the like to permit mounting the hitch to the bumper or frame of the vehicle using bolts. The hitch may also, in some circumstances, be welded to the bumper or fame of the vehicle. The hitch may be mounted in a manner that the main cross tube extends across the horizontal axis of the car at the front or rear of the vehicle with the receiver projecting away from the vehicle to permit sliding the insert into the receiver of the hitch. The receiver projects out from the center of the front or rear of the vehicle. A hitch pin or clip may be used to fasten the insert into the hitch.

As is known in the art, a winch carrier may be fastened into the hitch for a winch mounting system. A winch carrier is used to carry a winch on the vehicle. When the winch is mounted on the winch carrier, it is referred to herein as a “winch and carrier assembly.” Winches have been commonly used for moving objects and vehicles. In the typical application, one end of a wire rope is securely attached to a stationary object while the other end is wound around the drum of a winch. Of course, it is to be appreciated that the winch may also be secured to the stationary object with the winch rope securely attached to the object to be moved.

The standard portable winch carrier includes a cradle with a pair of handles at shoulder width apart to make it easy to carry the winch from one hitch to another. A shank extends from the center of the winch carrier and is received and fastened into the receptacle of the standard receiver hitch. The winch carrier may be removed from the vehicle or storage area and lifted using the cradle handles and plugged into the hitch as per conventional installation. This permits operating the winch anytime and anywhere and also permits moving the winch from one vehicle to another if both vehicles are equipped with receiver style hitches.

Conventional hitches, especially when used with a winch and carrier assembly, face the most extreme demands and must withstand the stress encountered in a particular situation. A winch mounting system must distribute the rated load of the winch along the vehicle frame i.e. they are designed to the vehicle's capabilities to withstand straight pulls, as well as side loads. This minimizes the possibility of changing the alignment of the vehicle, affecting its ride and handling. In addition, braking may be affected and capacity limited by hitch selection.

There is therefore a need for an improved receiver-style hitch that may be used with a variety and plurality of inserts and that reduces stress on common failure points of the standard receiver-style hitch. There is a further need for an improved receiver-style hitch that may be used in a winch mounting system that provides better ride, handling and braking and that can support full-size rigs and heavier recovery situations and enables carrying a winch on either end of a vehicle. There is also a need for an improved receiver hitch that may be used in a winch mounting system that positions the winch for optimum performance. There is a further need for an improved receiver style hitch that may be used in a winch mounting system and method whereby the winch and carrier assembly may be easily and quickly installed and removed by one person. There is an additional need for an improved receiver style hitch that may be used in a winch mounting system and method that has a strong and stable mounting platform. The present invention fulfills these needs and provides other related advantages.

### SUMMARY OF THE INVENTION

The present invention resides in an improved winch mounting system. The improved winch mounting system comprises, generally, a receiver hitch having a plurality of receivers and a winch carrier slidably mounted therein.

In one preferred form of the invention for a winch mounting system for the rear end of a vehicle, the receiver hitch includes a substantially straight main cross tube terminating at both ends with side mounting brackets that may be mounted to the vehicle frame. The plurality of receivers includes a middle receiver in a substantially central position with respect to the side mounting brackets and between and spaced apart from a pair of outer receivers. The middle receiver extends in a perpendicular direction from one side of the receiver hitch. The pair of outer receivers also extends in a perpendicular direction from the same side of the receiver hitch and may be spaced at about equal distances apart from the middle receiver at an off-center position with respect to the main cross tube. The outer receivers may be longer than the inside middle receiver. The winch carrier may be slidably mounted into the open ends of the outer receivers and fastened by a hitch pin or the like.

The winch carrier includes a cradle having a pair of handles and a face plate mounted on the front thereof. A pair of shanks extending behind the face plate is received in the outer receivers. As is known in the art, a winch may be mounted into the winch carrier for a “winch and carrier assembly.” The winch and carrier assembly may also include a conventional fairlead or cable guide assembly means for guiding the winch rope and thereby minimizing damage to the winch rope.

In another form of the invention for the front end of the vehicle, a front receiver hitch includes a substantially straight cross bar with downwardly sloping ends terminating at about a 90 degree angle in hitch mounting plates. The front receiver hitch includes a pair of spaced apart receivers in a substantially off-center position with respect to the hitch mounting plates. The winch and carrier assembly is removably mounted to the front hitch in the same manner as with the rear hitch i.e. by slidably mounting the winch carrier shanks into the receivers and inserting the hitch pin through aligned opposite paired openings. In another embodiment, the front receiver hitch may further include shackles mounted to a front face of the hitch mounting plates.

The receiver style hitch may be used with other inserts slidably mounted into one or more of the receivers. For example, one or more ball mounts (not shown) and/or one or more clevis mounts, etc. may be inserted in the receivers.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective assembly view of a winch mounting system embodying the invention, illustrating a winch carrier having a pair of rearwardly-extending shanks being inserted into corresponding receivers of a receiver style hitch;

FIG. 1A is a perspective view of the winch carrier, illustrating a face plate mounted on the front of the winch carrier and having a slot therein;

FIG. 1B is a front view of a winch and carrier assembly, illustrating a winch mounted on the winch carrier with its wire rope fed through the slot of the face plate and through a roller fairlead mounted to the front of the winch and carrier assembly;

FIG. 2 is a top view of the winch and carrier assembly of FIG. 1B, illustrating the wire rope wrapped around a winch drum and extending exteriorly from the winch;

FIG. 2A is a side view of the winch and carrier assembly of FIGS. 1B and 2;

FIG. 2B is a side perspective view of the winch and carrier assembly of FIGS. 1B, 2, and 2A slidably mounted into the receiver-style hitch mounted to the rear of a vehicle;

FIG. 3 is a perspective view of an alternative embodiment of a receiver-style hitch mounted to the front of a vehicle with mounting plates;

FIG. 3A is a perspective assembly view of the front mounted hitch of FIG. 3 receiving the winch and carrier assembly of FIGS. 1B-2A;

FIG. 3B is an alternative embodiment of the front mounted hitch of FIG. 3, illustrating a shackle on each of the mounting plates for the front mounted receiver;

FIG. 3C is a side view of one side of the front mounted hitch of FIG. 3B; and

FIG. 3D is a perspective side view of the front mounted hitch of FIGS. 3B and 3C receiving the winch and carrier assembly of FIGS. 1B-2A.

### DETAILED DESCRIPTION OF THE PREFERRED EMBODIMENTS

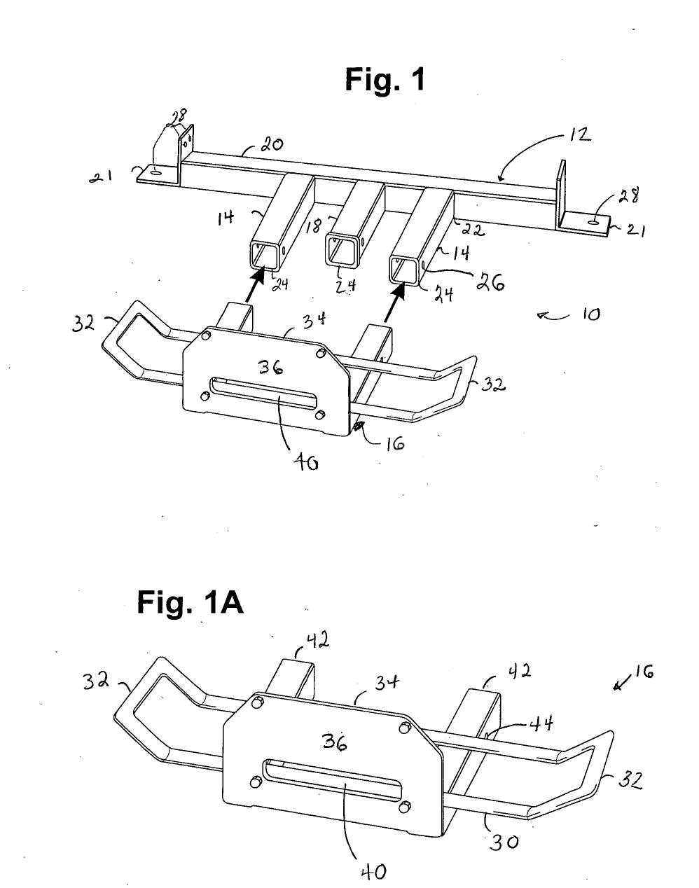

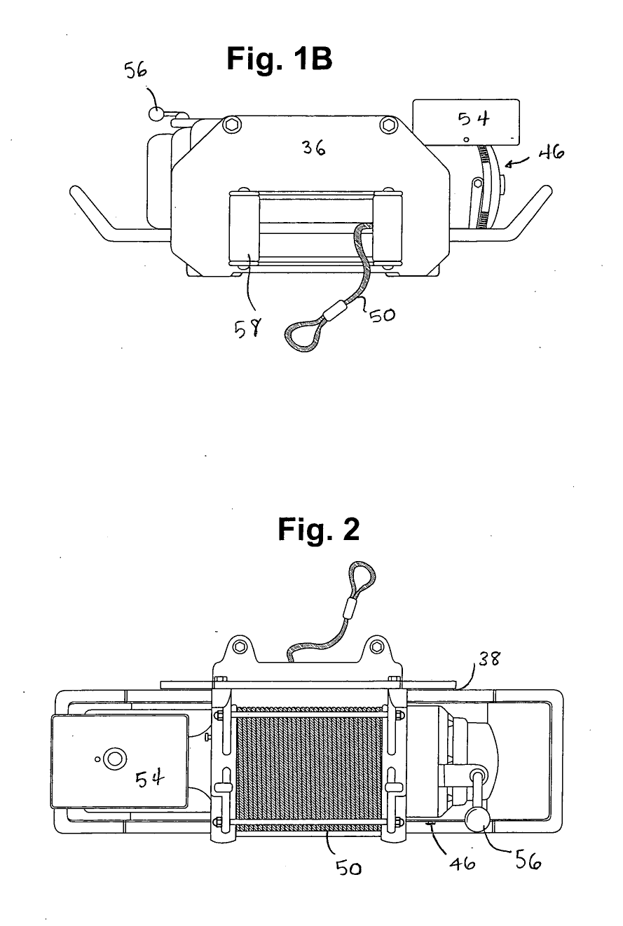

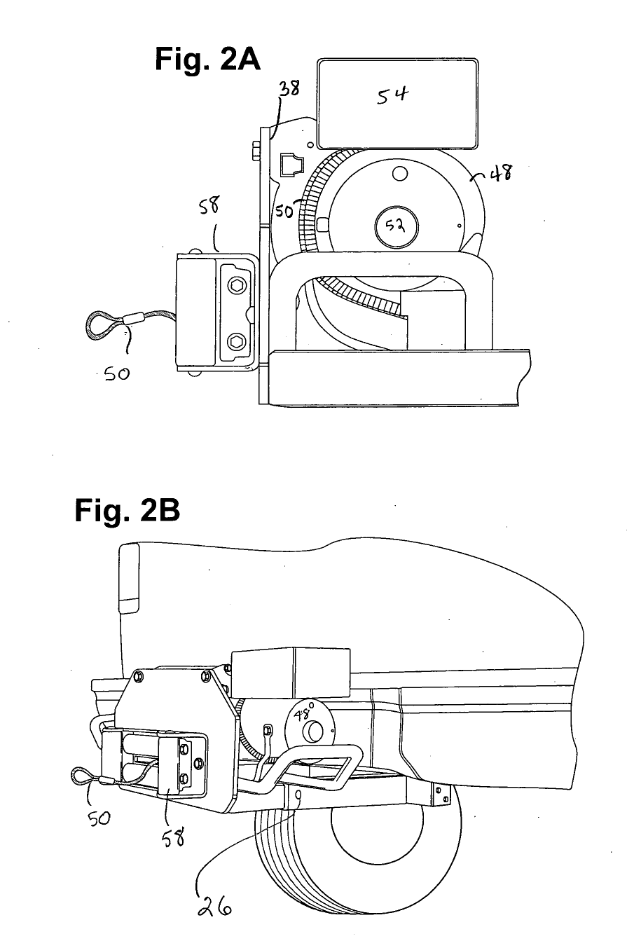

As shown in the drawings for purposes of illustration, the present invention as shown in FIGS. 1-2B is concerned with an improved winch mounting system, generally designated in the accompanying drawings by the reference number 10. The improved winch mounting system comprises, generally, a receiver hitch 12 having a pair of outer receivers 14; and a winch carrier 16 slidably mounted into the pair of outer receivers 14. The receiver hitch 12 may also include a middle receiver 18 between the pair of outer receivers 14. The receiver hitch 12 may be used with inserts other than the winch carrier 16 as hereinafter described.

In the first embodiment as shown in FIG. 1, the improved receiver hitch 12 includes a substantially straight square main cross tube 20 terminating at both, ends with side mounting brackets 21 with the middle receiver 18 in a substantially central position with respect to the side mounting brackets 21. As is known in the art and as shown in FIG. 1, the middle receiver 18 extends in a perpendicular direction from one side of the receiver hitch 12. The pair of outer receivers 14 also extends in a perpendicular direction from the same side of the receiver hitch 12 and may be spaced at about equal distances apart from the middle receiver 18 at an off-center position with respect to the main cross tube 20. The outer receivers 14 may be longer than the middle receiver 18. The pair of outer receivers 14 measure about 12.5 inches long and therefore extend about 4.5 inches beyond the standard eight inch middle receiver. The additional and deeper receivers allow for more weight transfer to the hitch, cross tube, side brackets and vehicle frame helping the hitch able to withstand heavier loads.

Each of the outer and middle receivers 14 and 18 has a first end and a second end 22 and 24. The first end 22 may be mounted by welding or the like to the one side of the main cross tube 20. The receiver hitch 12 may be an OEM or an aftermarket hitch. An aftermarket hitch may include a standard receiver-style hitch with one standard middle receiver to which the pair of outer receivers 14 may be added by welding or the like. The second end 24 of the receivers is the receptacle end for receiving the inserts. Opposite paired openings 26 in both sides of the receiver near the second end 24 are for purposes as described hereinafter. Although a square tube hitch is shown, it is to be appreciated that a round tube hitch may also be used.

The side mounting brackets 21 include attachment openings 28 through which fasteners (not shown) may be used to mount the main cross tube 20 to the frame or bumper at the rear of the vehicle as shown in FIG. 2B. Although side mounting brackets 21 are shown in the drawing, it is to be appreciated that the particular mounting brackets used will depend on the installation instructions and the type of vehicle to which the hitch is mounted.

The winch carrier 16 shown in FIGS. 1 and 1A includes a cradle 30 having a pair of handles 32 and a face plate 34 mounted on the front thereof. The face plate 34 includes a front side and a rear side 36 and 38 and a slot 40 therein for purposes as described hereinafter. A pair of shanks 42 extends rearwardly from the bottom of the rear side of the face plate in a perpendicular direction to and under the cradle 30. The pair of shanks 42 is slightly smaller in outside dimension than the inside dimension of the outer receivers 14 in order to be inserted therein. As shown in FIG. 2B, the pair of shanks 42 may be received in the corresponding pair of outer receivers 14. The shanks 42 include opposite paired openings 44 in the sides thereof just rearwardly of the cradle 30 for purposes as described hereinafter. The positioning of the opposite paired openings 44 in the shanks 42 is to space the winch carrier 16 away from the vehicle when the winch carrier is slidably mounted into the receiver hitch as shown in FIG. 2B. The opposite paired openings 44 in the shanks 42 are positioned to hold the cradle 30 about nine inches out from the vehicle.

As is known in the art and as shown in FIGS. 1B, 2, 2A and 2B, a winch 46 including a drum 48 for winding a wire rope 50 and a motor 52 which rotates the drum 48 may be mounted into the cradle 30 behind the rear side 38 of the face plate 34. The winch 46 further includes a control box 54 and clutch 56 as shown. When the winch is mounted on the cradle 30 of the winch carrier 16, it is referred to herein as a “winch and carrier assembly”. The wire rope 50 from the winch passes through the slot 40 in the face plate 34.

As shown in FIGS. 1B, 2A and 2B, the winch and carrier assembly may also include a conventional fairlead 58 or cable guide assembly means for guiding the wire rope 50 and thereby minimizing damage to the wire rope. The fairlead 58 surrounds the slot 40 in the face plate 34 and provides rollers for guiding the wire rope 50 onto and off of the winch drum 48. The fairlead 58 may be fixedly coupled by bolts to the front side 36 of the face plate 34 and into the winch 46 as shown in FIGS. 2A and 2B.

As shown in FIG. 2B, the winch carrier 16 may be slidably mounted into the pair of outer receivers 14 of the hitch until the opposite paired openings 26 and 44 in each of the pair of outer receivers 14 and the winch carrier shanks 42 are substantially aligned. The winch carrier 16 may be fastened to the hitch by inserting the hitch pin or clip (not shown) through the substantially aligned opposite paired openings 26 and 44. When so fastened, the combination of the hitch and winch carrier 16 are referred to herein as a winch mounting system.

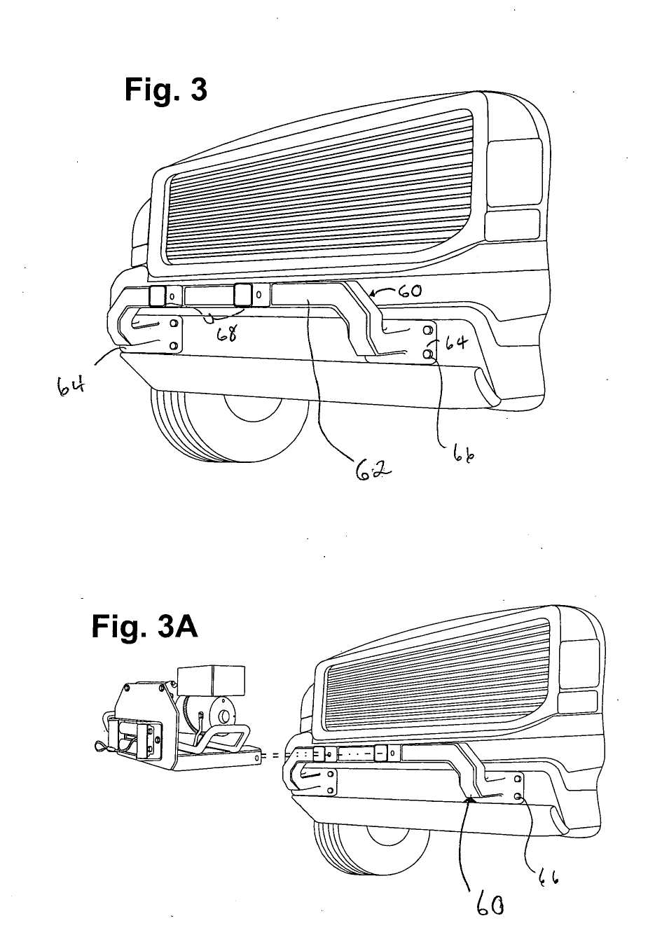

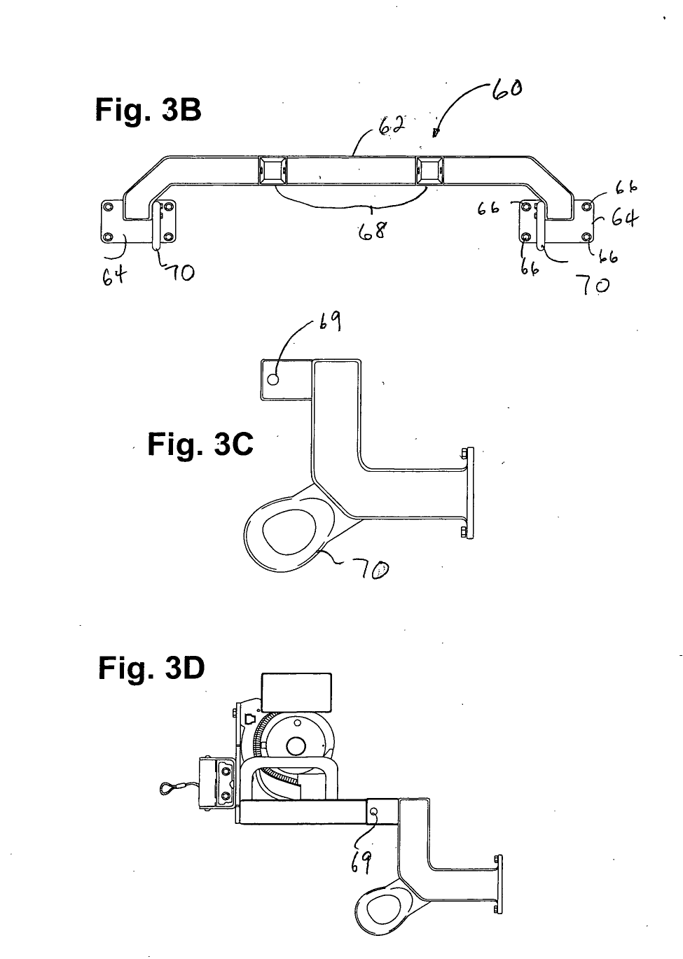

In an alternative embodiment as shown in FIGS. 3-3A, a front receiver hitch 60 includes a substantially straight main cross tube 62 with downwardly sloping ends terminating at about a 90 degree angle in hitch mounting plates 64. The front receiver hitch 60 may be bolted to the frame of the vehicle as shown in FIGS. 3 and 3A. It is to be appreciated that the front receiver hitch may in some applications be installed on the bumper of a vehicle. The hitch mounting plates 64 include attachment openings (not shown) for mounting bolts 66. The front receiver hitch 60 includes a pair of spaced apart outer receivers 68 in a substantially off-center position with respect to the hitch mounting plates 64. The outer receivers 68 include opposite paired openings 69 near the receptacle end. The outer receivers may be shorter than those previously described. The winch carrier 16 as shown in FIG. 1A or the winch and carrier assembly as shown in FIG. 3A may be removably mounted to the front receiver hitch 60 in the same manner as with the rear hitch i.e. by slidably mounting the winch carrier shanks into the receivers and inserting the hitch pin or clip (not shown) through the substantially aligned opposite paired openings.

Although a three receiver hitch on the rear end of the vehicle and a two receiver hitch on the front end of the vehicle has been described and shown, it is to be appreciated that substantial benefit may be derived from an alternative configuration of the invention whereby the three receiver hitch is mounted on the front of the vehicle and the two receiver hitch is mounted on the rear end of the vehicle.

In another embodiment as shown in FIGS. 3B-3D, the front receiver hitch 60 may further include shackles 70 mounted to a front face of the hitch mounting plates 64 as shown in FIG. 3B. The shackles project downwardly and forwardly as shown in FIGS. 3C and 3D. The shackles may be used as additional bracing for side pulls or for use to strap the winch to a rock or tree for vehicle-free winching or for other known purposes.

Although the receiver hitches have been described for use in a winch mounting system, it is to be appreciated that the receiver style hitch may be used with other inserts slidably mounted into one or more of the receivers. For example, one or more ball mounts (not shown) and/or one or more clevis mounts, etc. may be inserted into the receivers.

In operation, the receiver hitches of the present invention may be mounted to the vehicle by methods well known in the art. The winch and carrier assembly may be moved from the front or rear of the vehicle if there are front and rear hitches.

From the foregoing, it is to be appreciated that the receiver hitch of the present invention is readily adaptable for receiving a wide variety of inserts, including a winch carrier in a winch mounting system. Other inserts may also be mounted into the receiver hitch for a stable and strong vehicle mounting system.

Although a particular embodiment of the invention has been described in detail for purposes of illustration, various modifications may be made without departing from the spirit and scope of the invention. Accordingly, the invention is not to be limited, except as by the appended claims.

I claim:

1. A receiver hitch comprising:
a main cross tube including means to mount the main cross tube to a vehicle; and
a plurality of receivers extending from the main cross tube.

2. The receiver hitch of claim 1, wherein the main cross tube comprises a substantially straight main cross tube dimensioned to be coupled to a rear end of the vehicle.

3. The receiver hitch of claim 1, wherein the main cross tube comprises a substantially straight main cross tube with downwardly sloping ends terminating at about a 90 degree angle in a pair of hitch mounting plates, the substantially straight main cross tube dimensioned to be coupled to a front end of the vehicle.

4. The receiver hitch of claim 1, wherein the plurality of receivers comprises a pair of outer receivers at a substantially off-center position with respect to the main cross tube.

5. The receiver hitch of claim 4, wherein the plurality of receivers comprises a middle receiver extending from substantially the center of the main cross tube and positioned between and spaced apart from the pair of outer receivers.

6. The receiver hitch of claim 5, wherein the pair of outer receivers is longer than the middle receiver.

7. The receiver hitch of claim 1, further comprising one or more inserts slidably mounted into one or more of the plurality of receivers.

8. The receiver hitch of claim 7, wherein the one or more inserts comprises a winch carrier.

9. A vehicle comprising:
A vehicle body and a frame, the combination defining a front and rear end of the vehicle;
A receiver hitch mounted to at least one of the front and rear end of the vehicle, the receiver hitch including a plurality of receivers protruding forwardly of the front end and/or rearwardly of the rear end.

10. The vehicle of claim 9, wherein the receiver hitch is mounted to the rear end of the vehicle and the receiver hitch includes three receivers.

11. The vehicle of claim 10, wherein the three receivers include a middle receiver between and spaced apart from a pair of outer receivers.

12. The vehicle of claim 9, wherein the receiver hitch is mounted to the front end of the vehicle and includes a pair of outer receivers.

13. The vehicle of claim 9, wherein the pair of outer receivers is at a slightly off-center position with respect to the front end of the vehicle.

14. The vehicle of claim 11 and 12, wherein a winch carrier slidably mounts into the pair of outer receivers.

15. A winch mounting system comprising:
a hitch having a plurality of receivers; and
a winch carrier slidably mounted in the plurality of receivers.

16. The winch mounting system of claim 15, wherein the plurality of receivers comprises a pair of outer receivers.

17. The winch mounting system of claim 16, wherein the plurality of receivers further comprises a middle receiver between and spaced apart from the pair of outer receivers.

18. The winch mounting system of claim 16, wherein the winch carrier includes a pair of shanks slidably mounted into the pair of outer receivers.

19. The winch mounting system of claim 15, wherein the hitch further includes at least one shackle mounted to the hitch.
